(19) United States
(12) Patent Application Publication
(10) Pub. No.: US 2009/0218855 A1
(43) Pub. Date: Sep. 3, 2009

(54) CLIMATE CONTROL SYSTEMS AND DEVICES FOR A SEATING ASSEMBLY

(75) Inventor: Scott R. Wolas, Newbury Park, CA (US)

Correspondence Address: KNOBBE MARTENS OLSON & BEAR LLP, 2040 MAIN STREET, FOURTEENTH FLOOR, IRVINE, CA, 92614, US

(73) Assignee: Amerigon Incorporated, Northville, MI (US)

(21) Appl. No.: 12/393,857

(22) Filed: Feb. 26, 2009

Related U.S. Application Data
(60) Provisional application No. 61/031,625, filed on Feb. 26, 2008.

(51) Int. Cl. B60N 2/56; B60H 1/00; A47C 7/74

(52) U.S. Cl. 297/180.14; 297/180.13; 297/180.12; 297/217.3; 454/120

(57) ABSTRACT

According to some embodiments disclosed in the present application, a climate control device configured for use with a seating assembly includes a fluid module having a fluid transfer device. The climate control device further comprises a fluid duct in fluid communication with the fluid module, wherein the fluid duct includes a distal end. The additional includes at least one outlet opening positioned at the distal end of the fluid duct. In some arrangements, the fluid duct is configured to be positioned at, near or through a seat bite area of the seating assembly. In other arrangements, the fluid module is configured to selectively transfer air to or from the at least one outlet opening through the fluid duct.

### CROSS-REFERENCE TO RELATED APPLICATIONS

This application claims the priority benefit under 35 U.S.C. § 119(e) of U.S. Provisional Application No. 61/031,625, filed Feb. 26, 2008, the entirety of which is hereby incorporated by reference herein.

### BACKGROUND

1. Field of the Inventions

This application relates to climate control, and more specifically, to climate control of a seat assembly.

2. Description of the Related Art

Temperature modified air for environmental control of living or working space is typically provided to relatively extensive areas, such as entire buildings, selected offices, or suites of rooms within a building. In the case of vehicles, such as automobiles, the entire vehicle is typically cooled or heated as a unit. There are many situations, however, in which more selective or restrictive air temperature modification is desirable. For example, it is often desirable to provide individualized climate control for an occupant seat so that substantially instantaneous heating or cooling can be achieved. For example, an automotive vehicle exposed to the summer weather, especially where the vehicle has been parked in an unshaded area for a long period of time, can cause the vehicle seat to be very hot and uncomfortable for the occupant for some time after entering and using the vehicle, even with normal air conditioning. Furthermore, even with normal air-conditioning, on a hot day, the seat occupant's back and other pressure points may remain sweaty while seated. In the winter time, it may be desirable to quickly warm the seat of the occupant in order to enhance an occupant's comfort. This is particularly true where a typical vehicle heater is unlikely to quickly warm the vehicle's interior. For these and other reasons, there have long been various types of individualized climate control systems for vehicle seats.

Such climate control systems typically include a distribution system comprising a combination of channels and passages formed in one or more cushions of a seat. Climate conditioned air can be supplied to these channels and passages by using a climate controlled device. Climate conditioned air flows through the channels and passages to cool or heat the space adjacent the surface of the vehicle seat.

There are, however, problems that have been experienced with existing climate control systems for seats. For example, some climate control systems are not easily integratable into existing seat construction methods. Such systems require a significantly greater number of parts as compared to existing automotive seats, and often require complex mechanical parts. In the past, this has resulted in increased costs for individualized occupant cooling in automobiles. Also, the mechanical comfort of the seat is appreciably affected in the systems employed, as compared to the comfort provided by standard automotive seats. Often the user is able to distinguish between the comfort of seats with individualized occupant cooling and standard automotive seats. Further, the current techniques are problematic because they may limit the ability for vehicle designers to provide modern seating embodiments and stylistic designs. Thus there is a need for an improved climate control system for vehicle and other types of seats.

### SUMMARY

According to some embodiments disclosed in the present application, a climate control device configured for use with a seating assembly includes a fluid module having a fluid transfer device. The climate control device further comprises a fluid duct in fluid communication with the fluid module, wherein the fluid duct includes a distal end. The additional includes at least one outlet opening positioned at the distal end of the fluid duct. In some arrangements, the fluid duct is configured to be positioned at, near or through a seat bite area of the seating assembly. In other arrangements, the fluid module is configured to selectively transfer air to or from the at least one outlet opening through the fluid duct.

In certain embodiments, the fluid module further comprises one or more thermoelectric devices (e.g., Peltier circuit) or other heating and/or cooling devices configured to selectively thermally condition air being transferred through the fluid duct. In other arrangements, the distal end of the fluid duct generally terminates at or near the seat bite of the seat assembly. In one embodiment, the device further comprises a fluid distribution member positioned at the distal end of the fluid duct, such that the fluid distribution member is configured to help distribute air from the fluid duct toward an occupant seated in the seating assembly.

According to other arrangements, the distal end of the fluid duct generally extends through the seat bite of the seat assembly. In some embodiments, the device further includes at least one fluid chamber or pad disposed along the seat back portion and/or the seat bottom portion of the seating assembly. In one embodiment, such a fluid chamber comprises a first surface adapted to be positioned against a front surface of the seat back portion or the seat bottom portion and a second surface generally opposite of the first surface. The fluid chamber or pad is configured to permit air to pass through said second surface toward a seated occupant. In certain arrangements, the fluid module is configured to selectively transfer air to or from the fluid chamber, through the fluid duct.

In certain embodiments, fluid chambers are configured to be positioned along an exterior of the seat back portion and/or the seat bottom portion. In other arrangements, the fluid chambers are configured to be positioned along an interior of the seat back portion and/or the seat bottom portion. In one embodiment, the climate control device is an after-market device configured to be installed on a completed seating assembly. In other arrangements, the device additionally includes a cover generally positioned along an outlet opening to prevent objects from falling through the outlet opening. In other embodiments, the device further comprising a power adapter configured to be selectively inserted within a power outlet to supply electrical power to the fluid module. In one embodiment, the power adapter is configured to be inserted into a cigarette lighter or some other standard or non-standard automotive power outlet. In other arrangements, the climate control device additionally includes a controller configured to regulate at least one operational aspect of the fluid module.

According to certain embodiments, a climate control system configured to be removably installed on a seating assembly includes a fluid module having a fluid transfer device and a thermoelectric device (e.g., Peltier circuit) or some other cooling/heating device and a fluid duct in fluid communication with the fluid module and the thermoelectric device. The fluid duct is configured to be routed or otherwise positioned through a seat bite area of a seating assembly. The climate control system additionally includes at least one fluid chamber configured to be disposed along a seat back portion and/or a seat bottom portion of the seating assembly. The fluid chamber comprises walls that define an interior space, which is in fluid communication with the fluid duct. In some embodiments, at least a portion of the walls of the fluid chamber is configured to be air-permeable (e.g., are porous or include a plurality of openings). The fluid module is configured to selectively transfer air through the fluid duct and the at least one fluid chamber, through the at least a portion of the walls of the fluid chamber that is air-permeable. In one embodiment, thermoelectric device is configured to selectively heat and/or cool air being transferred by the fluid transfer device.

According to other arrangements, the fluid chambers or pads are configured to be positioned along an exterior of the seat back portion and/or the seat bottom portion. In alternative embodiments, the fluid chambers are configured to be positioned along an interior of the seat back portion and/or the seat bottom portion. In one embodiment, at least one fluid chamber comprises a spacer material, such as, for example, a spacer fabric, spacer structure and/or the like. Such a spacer material can be configured to maintain a desired spacing within the fluid chamber or pad and/or facilitate in fluid distribution therein. In certain arrangements, the fluid module is configured to be secured along a rear side of the seat back portion and/or along a bottom side of the seat bottom portion.

In some arrangements, the climate control system is an after-market device configured to be installed on a completed seating assembly. In other embodiments, the seating assembly comprises a vehicle seat, a bed, a wheelchair, another medical chair or bed, a sofa, a stadium or theater seat, a desk chair and/or the like. In other embodiments, the system further comprising a power adapter configured to be selectively inserted within a power outlet to supply electrical power to the fluid module. In one embodiment, the power adapter is configured to be inserted into a cigarette lighter or some other standard or non-standard automotive power outlet. In other arrangements, the climate control system additionally includes a controller configured to regulate at least one operational aspect of the fluid module (e.g., flowrate of the fluid transfer device, amount of heating or cooling provided by the thermoelectric device, etc.).

According to some embodiments of the present inventions, a vehicle seat comprises a seat bottom portion, a seat back portion, a duct generally positioned in an area between the seat bottom portion and the seat back portion, at least one duct opening at or near an end of the duct and a fluid transfer device being configured to provide fluid to the duct opening in the direction of a seated user.

In some embodiments, a seat assembly includes a seat bottom, a seat back, a seat bite area generally positioned at an interface between the seat bottom and the seat back and a duct having a first end and a second end. The first end being in fluid communication with the second end, and the first end of the duct positioned at or near the seat bite area. The seat assembly further includes one or more duct openings at or near the first end of the duct and a fluid module configured to supply or remove a volume of fluid through the duct opening. In some embodiments, the seat assembly comprises a vehicle seat, a bed, a wheelchair, a stadium seat, a sofa, a desk chair and/or the like.

According to some embodiments, the fluid module includes a fluid transfer device. In one embodiment, the fluid module comprises a thermoelectric device configured to selectively heat or cool a fluid. In other embodiments, the thermoelectric device comprises a Peltier circuit. In other arrangements, the seat assembly further comprises a duct cover configured to be placed on or near the duct opening. In some embodiments, the seat bottom or the seat back is covered by a seat covering. The duct cover comprises a material that is the same or similar to the seat covering.

In one embodiment, the seat bottom and/or the seat back of the seat assembly includes a fluid distribution system. In some embodiments, the fluid module is configured to simultaneously deliver fluid to both the duct and the fluid distribution system. In another arrangement, the fluid distribution system comprises a plurality of channels. In some embodiments, the fluid distribution system comprises an insert adapted to be positioned within the seat bottom or seat back. In other embodiments, an air flow resistance through the duct is greater than, equal to or lesser than an air flow resistance through the fluid distribution system. In one embodiment, an inner periphery of the duct is smaller than, equal to or lesser than an inner periphery of the channels.

In some embodiments, a seat assembly comprises a seat bottom portion, a seat back portion, a duct located generally between the seat bottom portion and the seat back portion and a fluid transfer device configured to provide climate conditioned or unconditioned air to the duct. In other embodiments, a seat bite line duct includes a first end configured to be located generally between a seat back and a seat bottom of a vehicle seat and a second end configured to be in fluid communication with a fluid distribution system, the second end adapted to receive a volume of fluid. In one embodiment, the fluid distribution system includes a fluid module, and the duct is configured to provide a temperature conditioning effect to an occupant positioned on the vehicle seat.

In one embodiment, a method of incorporating a climate control system to a seat assembly having a seat back portion and a seat bottom portion comprises positioning a duct at or near the seat bite line of a seat assembly. The seat bite line is generally located between the seat bottom portion and the seat back portion of the seat assembly. The duct includes one or more duct openings through which a volume of fluid can be selectively delivered or withdrawn. The method further includes providing a fluid module in fluid communication with the duct and activating the fluid module to transfer fluid to or from the duct.

In some embodiments, the fluid module includes a fluid transfer device. In one embodiment, the fluid module further comprises a thermoelectric device. In other embodiments, the seat back portion and/or the seat bottom portion further comprises a fluid distribution system. In yet another arrangement, the fluid module is adapted to provide fluid to both the duct and the fluid distribution system.

In some embodiments, a vehicle seat comprises a seat bottom portion, a seat back portion, a duct having a first end and a second end, the duct being generally positioned between the seat bottom portion and the seat back portion, a duct opening at the first end of the duct and a fluid transfer device being configured to provide a fluid to the duct opening through the second end toward a seated user. In some embodiments, a thermoelectric device or another temperature or other type of conditioning device can be used to selectively heat, cool, dehumidify or otherwise affect one or more properties of the fluid being delivered to the seating assembly.

Accordingly, one embodiment of the present invention involves a vehicle seat comprising a seat bottom, a seat back, and a duct. The duct has a duct opening located at a seat bite line, where the seat bite line is the region between seat back and seat bottom. The duct is in fluid communication with a fluid module. The fluid module can include a fluid transfer device, such as a blower or fan. The fluid module can also optionally include a climate control device. The duct opening provides conditioned air to a person sitting in the vehicle seat.

Another embodiment of the present invention comprises a seat bite line duct. The duct has a first end and a second end. At the first end is a duct opening. The duct opening is located in the seat bite line of a seat assembly. The duct opening can optionally be covered by a duct cover. The second end of the duct is in fluid communication with a fluid module. The duct opening provides conditioned air to a person sitting in the vehicle seat.

Yet another embodiment involves a vehicle seat comprising a seat bottom, a seat back, a duct and a fluid distribution system. The duct is in fluid communication with a plurality of channels making up the fluid distribution system. The plurality of channels may be located in the seat bottom, in the seat back or in both the seat bottom and the seat back. The duct has a duct opening. The fluid distribution system is in fluid communication with a fluid module. The duct opening is located in the seat bite line. The duct opening provides conditioned air to a person sitting in the vehicle seat.

Another embodiment of the present invention is a method of providing a volume of fluid to a seat bite line. The method comprising, providing a duct at a seat bite line, the seat bite line being formed at a juncture between a seat bottom and a seat back in a vehicle seat. The method further comprising maintaining a fluid module in fluid communication with the duct. The method yet further comprising, conditioning a fluid in the fluid module and providing the conditioned fluid from the fluid module to the duct.

The disclosed climate controlled seat assembly can lead to decreased manufacturing costs. The seat bite line duct is easy to install and may reduce or eliminate modifications to existing seat designs. Use of the disclosed system can also increase the perception of conditioned air by the user. This can advantageously lead to increased comfort to the user.

### BRIEF DESCRIPTION OF THE DRAWINGS

These and other features, aspects and advantages of the present inventions are described herein in connection with certain preferred embodiments, in reference to the accompanying drawings. The illustrated embodiments, however, are merely examples and are not intended to limit the inventions presented herein. The drawings include the following figures.

FIG. 1 illustrates a perspective view of a climate controlled vehicle seat according to one embodiment;

FIG. 2 illustrates a perspective view of a bottom assembly of a climate controlled vehicle seat comprising channels and an insert positioned herein according to one embodiment;

FIG. 3A schematically illustrates a side view of a climate controlled seat having a fluid duct at or near the seat bite according to one embodiment;

FIG. 3B schematically illustrates a side view of a climate controlled seat having a fluid duct at or near the seat bite according to another embodiment;

FIG. 3C schematically illustrates a side view of a climate controlled seat having a fluid duct at or near the seat bite according to a different embodiment;

FIG. 4 illustrates a perspective view of a climate controlled vehicle seat having a fluid duct at or near the seat bite line according to one embodiment;

FIGS. 5A-5C illustrate top, front and side views, respectively, of a fluid duct configured for placement in a seat bite of a seating assembly according to one embodiment;

FIG. 6 schematically illustrates a side view of a seat assembly that comprises a fluid module and a fluid duct positioned at or near the seat bite according to one embodiment;

FIG. 7 schematically illustrates a side view of a climate controlled seat having a fluid duct at or near seat bite and a distribution member within a seat bottom portion according to one embodiment;

FIG. 8 schematically illustrates a side view of a climate controlled seat having a fluid duct at or near seat bite and a distribution member within a seat back portion according to one embodiment;

FIG. 9A schematically illustrates a side view of one embodiment of a climate control system positioned on a seating assembly;

FIG. 9B illustrates a frontal perspective view of the climate control system and seating assembly of FIG. 9A;

FIG. 10A schematically illustrates a side view of another embodiment of a climate control system positioned on a seating assembly;

FIG. 10B illustrates a frontal perspective view of the climate control system and seating assembly of FIG. 10A;

FIG. 11A schematically illustrates a side view of a different embodiment of a climate control system positioned on a seating assembly;

FIG. 11B schematically illustrates a side view of yet another embodiment of a climate control system positioned on a seating assembly;

FIG. 12A schematically illustrates a partial side view of one embodiment of a climate control system positioned on a seating assembly;

FIG. 12B illustrates a frontal perspective view of the climate control system and seating assembly of FIG. 12A;

FIG. 13A schematically illustrates a side view of another embodiment of a climate control system positioned on a seating assembly;

FIG. 13B illustrates a detailed view of the climate control system and seating assembly of FIG. 13A;

FIGS. 14A-14C illustrates partial cross-sectional view of various embodiments of a fluid chamber or pad;

FIG. 15 illustrates a side view of an after-market climate control system configured to be removably attached to a seating assembly according to one embodiment; and

FIG. 16 schematically illustrates a side view of one embodiment of a seating assembly with the climate control system of FIG. 15 installed thereon.

### DETAILED DESCRIPTION OF THE PREFERRED EMBODIMENTS

The climate control devices disclosed herein, as well as the various systems and features associated with them, are described in the context of a thermally conditioned seating assembly because they have particular utility in this context. However, the climate control devices, systems and methods described herein, or equivalents thereof, can be used in other contexts as well, such as, for example, but without limitation, other devices or systems where thermally-conditioned fluids are desired or required, electronic or other components where thermal conditioning is desired or required and/or the like.

To assist in the description of the disclosed embodiments, words such as up, upward, upper, top, down, downward, lower, bottom, vertical, horizontal, upstream, downstream and the other directional, direction-indicating words and/or the like are used to describe the accompanying figures. However, the illustrated embodiments can be located, configured and/or oriented in a variety of desired positions and should not be limited in scope by the use of such descriptive words herein.

According to some embodiments, the climate control system disclosed herein can be incorporated into a seating assembly (e.g., a vehicle seat, a bed, a chair, etc.) by a manufacturer, assembler or other party prior to its acquisition by an end user. In alternative arrangements, however, the climate control system can be an after-market item that is intended to be positioned on a seating assembly by the consumer or another party after the seating assembly has already been provided to the consumer.

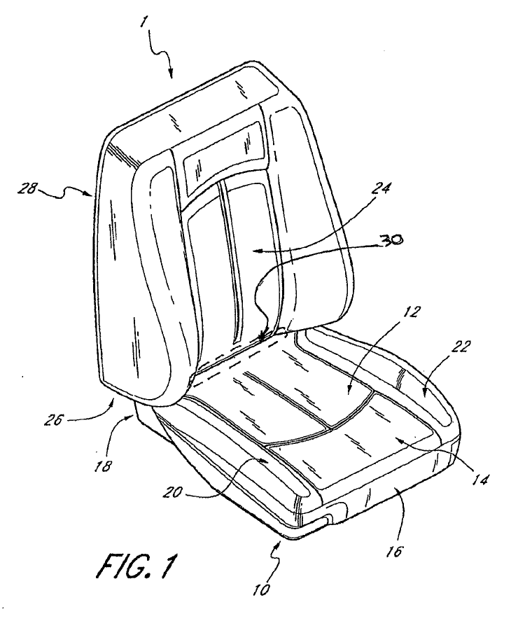

FIG. 1 illustrates an embodiment of a seat assembly 1 having a seat bottom portion 10 and a seat back portion 24. The depicted seat assembly 1 is configured to accommodate a person in a sitting position, reclined position and/or any other position. By way of example, when a person is seated in the seat assembly 1, at least a portion of the person's legs can be supported by a thigh area 14 of the seat bottom portion 10.

As discussed, for convenience, the various embodiments of the climate control devices and systems disclosed herein are discussed and illustrated with reference to a vehicle seat. However, such devices, systems and related methods can be incorporated into and/or used with any other type of seating assembly, including, without limitation, beds, office chairs, wheelchairs, other medical beds or chairs and the like.

With continued reference to FIG. 1, the seat assembly 1 can comprise a front end 16 and a rear end 18. The seat assembly 1 can also include a pair of sides 20, 22 extending between the ends for providing lateral support to the occupant of the seat assembly 1. As shown, the rear end 18 can be configured to be coupled to a seat back 24 such that the seat bottom 10 and seat back 24 cooperate to define a sitting area.

The rear end 18 of the seat assembly 1 can be coupled to a bottom end 26 of the back assembly 28. The juncture between the seat bottom 10 and the seat back 24 generally forms a seat bite line 30 or area. When the occupant sits in the seat, the occupant's back can contact the surface of the back assembly 28 and the occupant's seat and legs can contact a surface of the seat assembly 1. Preferably, the surfaces of the seat assembly 1 can cooperate to support the occupant, preferably in a comfortable sitting position. The seat assembly 1 can be sized, shaped and otherwise configured to accommodate occupants of various sizes and weights. One of ordinary skill in the art can determine the appropriate size and configuration of the seat to achieve the desired sitting area for a particular person and vehicle.

With continued reference to FIG. 1, the seat assembly 1 is similar to a standard automotive seat. However, as discussed above, certain features and aspects of the seat assembly 1 described and/or illustrated herein may also be used in a variety of other applications and environments. For example, certain features and aspects of the seat assembly 1 may be adapted for use in other vehicles, such as, for example, airplanes, boats, and/or the like. Further, certain features and aspects of the seat assembly 1 may also be adapted for use in stationary environments, such as, for example, chairs, office or task chairs, beds, mattresses, sofas, theater seats, wheelchairs, other medical chairs or beds and/or other seats that are used in a place of business, residence or the like.

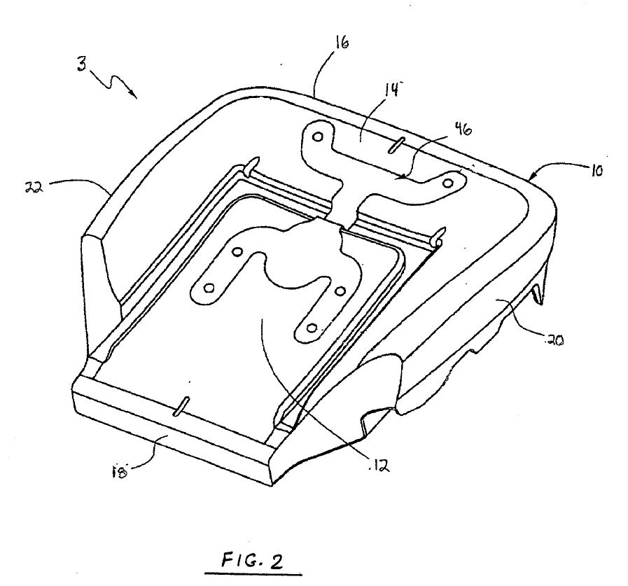

Typically, presently-known climate controlled seats use complex fluid distribution systems 46. For example, a seat assembly can include one or more channels or other passages through which air or other fluids may pass. In some embodiments, as illustrated in FIG. 2, such channels comprise an insert 46. Channels or other fluid passages formed on and/or within a portion of a seat assembly can be advantageously placed in fluid communication with a fluid module 40 to provide thermally-conditioned (e.g., heated, cooled, dehumidified, etc.) and/or unconditioned (e.g., ambient) fluid (e.g., air) to one or more portions of a seat assembly 1. Thus, when a person is seated on or along the seat area 12 of the seat bottom assembly 3 at least a portion of his or her legs can be supported by the thigh area 14 and the insert 46 is configured to help distribute and deliver air to (and/or remove air from) the cabin space of a vehicle thereby providing a more comfortable environment. As discussed above, climate controlled seat bottom assemblies 3, such as the one illustrated in FIG. 2, generally require the seat bottom 10 to include one or more channels, passages or other cutouts. Consequently, in such arrangements, the cost and complexity of manufacturing, assembling and/or otherwise making climate controlled seats can undesirably increase.

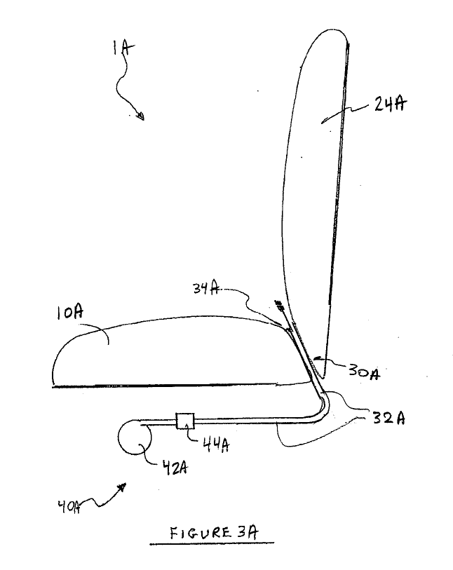

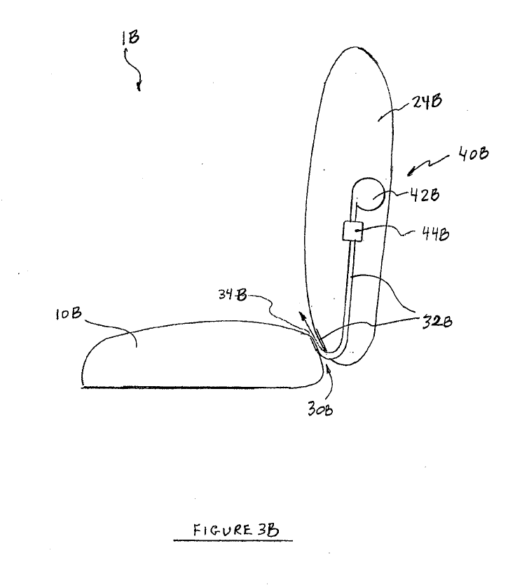

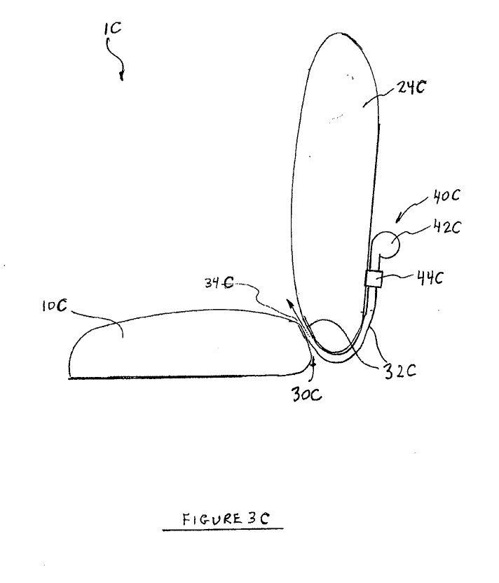

FIG. 3A illustrates a schematic view of one embodiment of a climate controlled vehicle seat 1 adapted to provide ambient and/or thermally conditioned fluids (e.g., heated or cooled air) to an occupant seated therein. According to some arrangements, the seat assembly 1A includes a seat bottom portion 10A, a seat back portion 24A and a duct 32A that is generally configured to terminate or be routed between the seat bottom and seat back portions 10A, 24A (e.g., at or near the seat bite of the seat assembly 1A). Thus, as shown, the duct 32A can be adapted to place the fluid module 40A in fluid communication with one or more front or exposed portions of the seat assembly 1A. Consequently, the fluid duct 32A can comprises one or more air impermeable or substantially air-impermeable materials to help ensure that fluid conveyed therethrough do not leak before an intended outlet (e.g., opening 34A). The fluid duct 32A can include one or more openings 34A located at and/or near the seat bite 30A. As used herein, the “seat bite” or the “seat bite line” is the area or region generally located between the seat back portion 24A and seat bottom portion 10A of a vehicle seat or other seating assembly.

With continued reference to FIG. 3A, the fluid duct 32A can be selectively placed in fluid communication with a fluid module 40A. The fluid module 40A can include a fluid transfer device 42A, such as, for example, a blower, fan and/or the like, that is used to impart energy on a fluid (e.g., air) to move such a fluid in a desired manner. The fluid module 40A can also include a climate control device 44A which is configured to selectively temperature-condition (e.g., heat, cool, dehumidify, etc.) the fluid being delivered by the fluid transfer device 42A. As discussed in greater detail herein, such a climate control device 44A can include a thermoelectric device, such as, for example, a Peltier element.

In embodiments where the duct opening 34A is located at or near the seat bite 30A of the seating assembly 1A, the need for specially molded vehicle seats or cut outs that receive fluid distribution members (e.g., inserts) or other components of a more complication climate controlled seat can be advantageously reduced or even eliminated. In one embodiment, a distal end of the duct 32A is shaped, sized and otherwise adapted to generally fit between the seat bottom and the seat back portions, thereby eliminating the need to provide specially-designed channels, passages, inlets, recesses and/or other features in a climate controlled seat. As discussed, such simplified designs can reduce costs and facilitate assembly and other aspects of providing a climate controlled seat assembly. However, as discussed in greater detail herein, a climate controlled seat assembly can include one or more other ducts, channels, inserts and/or the like, either in lieu of or in addition to a duct positioned at or near the seat bite 30A.

Moreover, according to certain arrangements, one or more fluid ducts are configured to deliver a volume of conditioned (e.g., heated, cooled, dehumidified, etc.) and/or unconditioned (e.g., ambient) fluid (e.g., air) to other portions of the seat assembly. In some embodiments, the fluid can be delivered to one or more areas of the seat assembly which are generally not contacted by a seated occupant. For example, the fluid can be delivered along one or more of the sides of the seat assembly, in the seat bite area and/or any other area. Therefore, the conditioned and/or unconditioned fluid can be directed in the direction of portions of the occupant's body that generally do not contact a surface of the seat assembly, such as, for example, the lower back, legs, neck and/or the like. Although the embodiments discussed and/or illustrated herein disclose seat assemblies having a fluid duct positioned at or near the seat bite of the seat assembly, such fluid ducts or other fluid delivery members can be positioned along other portions of the seat assembly. In fact, in some embodiments, fluid ducts are not attached or associated with the seat assembly (e.g., they can be attached to an adjacent surface of the vehicle interior, such as, for example, the center console, a door and/or the like).

As discussed in greater detail herein, a climate control system can be incorporated into a seating assembly (e.g., automotive or other vehicle seat, bed, etc.) either before or after such a seating assembly has been sold or otherwise provided to the consumer or other end-user. For example, in some embodiments, the manufacturer or assembler of the vehicle seat or the vehicle into which such a seat is to be installed modifies the seat with a climate control system. In alternative arrangements, the climate control system is configured to be installed into or on the seating assembly by the consumer (or other end-user) or some other after market installer. Thus, according to certain embodiments, the thermal module, ducts and/or any other components of a climate control system, such as one of those disclosed herein, or equivalents thereof, are adapted to be after-market items that can be easily and conveniently provided to a seating assembly by consumers.

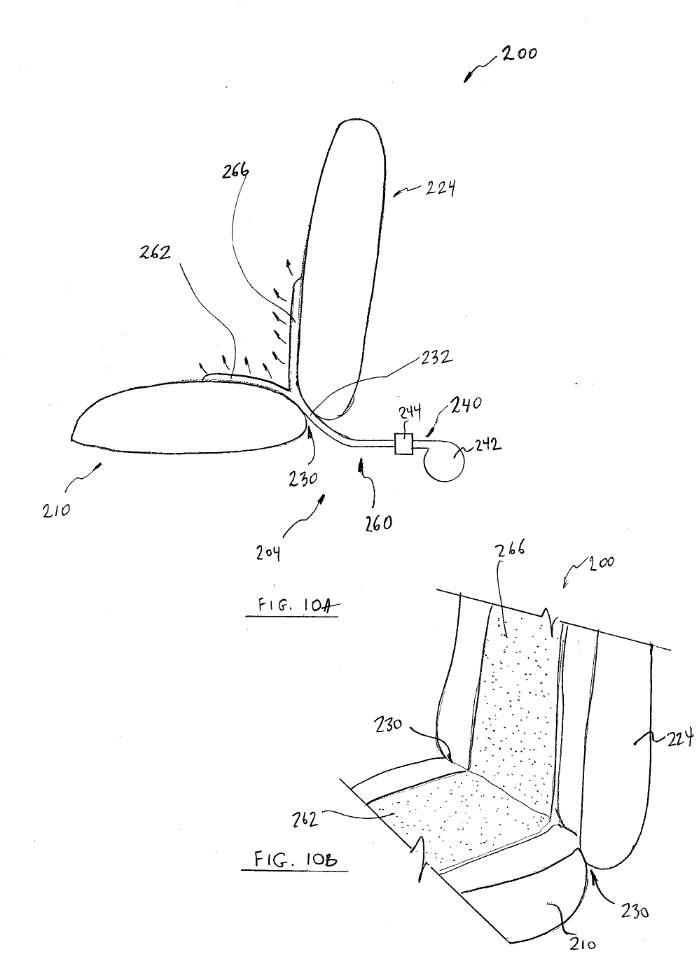

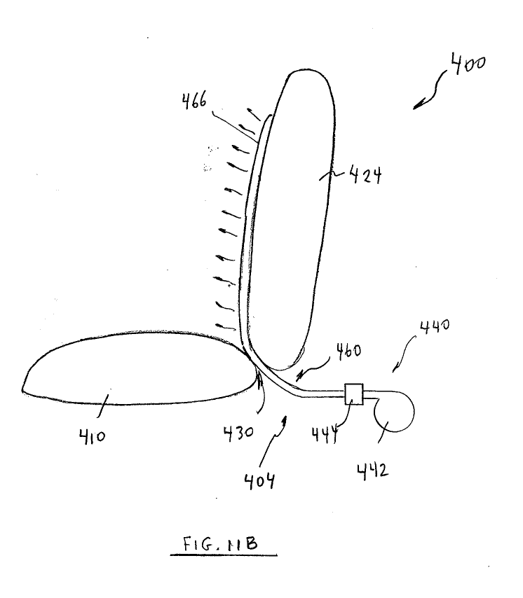

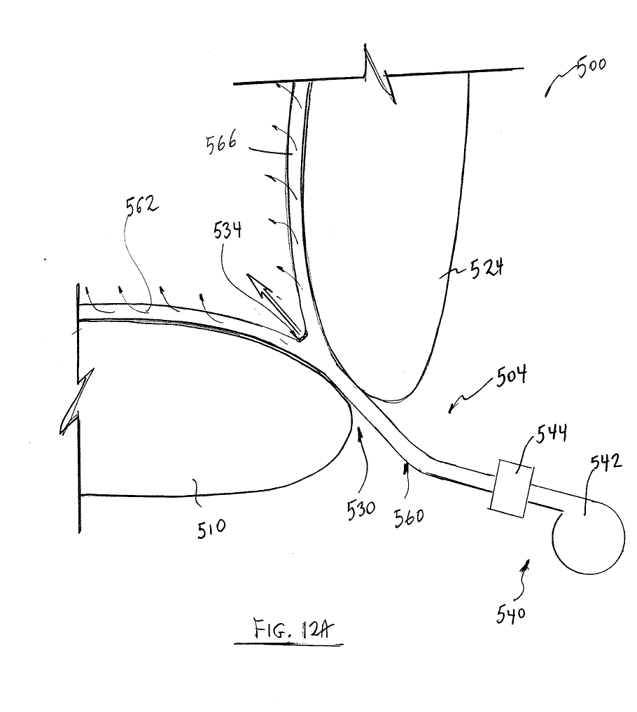

In some of the embodiments disclosed herein, or variations thereof, the fluid module 40A and/or other components of the climate control system (e.g., ducts) are located in any of a variety of locations. For example, the fluid module 40A can be located under the seat bottom portion 10A or behind the seat back portion 24A. Alternatively, the fluid module 40A can be positioned within the seat bottom portion 10A and/or the seat back portion 24A, between two seat assemblies 1A (e.g., within or under a center console) and/or at any other location, as desired or required. As discussed in greater detail therein, the fluid module 40A can also be in fluid communication with a single duct 32A or with multiple ducts. In some embodiments, the ducts 32A are generally configured to be located at or near the seat bite line 30A of one or more seat assemblies 1A. For example, the distal end of such a duct 32A can terminate at or near the seat bite line 30A. In other embodiments, as discussed in greater detail herein with reference to FIGS. 10A-10C and 12, the duct can extend through the seat bite of a seating assembly to other portions of the seat assembly (e.g., on or underneath the exposed surface of the seat bottom and/or seat back portions).

As illustrated in the embodiment of FIG. 3B, some, most or all of the components of the climate control system (e.g., the fluid module 40B, the fluid duct 32B, etc.) can be positioned on or within the seat bottom portion 10B and/or the seat back portion 24B of the seat assembly 1B. For example, the blower or other fluid transfer device 42B, the thermoelectric device 44B and one or more fluid conduits configured to deliver air or other fluid from the fluid module 40B to the duct 32B can be located within an interior portion of the seat back portion 24B. In any of the embodiments disclosed herein, the various components of the fluid module, such as, for example, a fluid transfer device, a thermoelectric device, a sensor, a controller and/or the like, can be located within a single housing or enclosure. In other arrangements, only some of those components are located within a housing or other enclosure, as desired or required. In some embodiments, such components are located within a cavity area generally between a cushion and a covering material along the rear side of the seat back portion. However, one or more of these components can be located along a surface of the seat back and/or seat bottom portion or on or within a different part of the seating assembly, as desired or required by a particular application or use.

As illustrated in FIG. 3C, the fluid module 40C can be positioned along a rear side of the seat back portion 24C of the seat assembly 1C. As shown, the fluid module 40C can comprise a fluid transfer device 42C (e.g., blower, fan, etc.), a thermoelectric device 44C or other temperature conditioning device, one or more conduits (e.g., fluid duct 32C) to transfer fluid to and/or from the front side of the seating assembly 1C. In some arrangements, one, some or all of the various components of the fluid module 40C are secured to one or more surfaces of the seat back portion 24C and/or the seat bottom portion 10C using adhesives, fasteners and/or any other attachment device or method.

For aesthetic, safety and/or any other reasons, the fluid module 40C can be completely or partially disposed within a protective area (e.g., within a housing or other enclosure, within a cavity of the seat assembly, etc.). As discussed in greater detail herein, the fluid module 40C can be located underneath the seat back portion 10C. In any of the embodiments disclosed herein, or equivalents thereof, the fluid transfer device, thermoelectric device and/or any other component of the seat assembly can be connected to an electrical power source (e.g., automobile's main electrical system, another hardwired AC or DC connection, battery, solar panel, etc.), control and instrumentation connections and/or the like. In addition, the seat assembly can comprise one or more sensors (e.g., thermistors, other temperature sensors, humidity sensors, etc.), a control module and/or the like to permit a user to automatically or manually operate the climate control system in a desired manner.

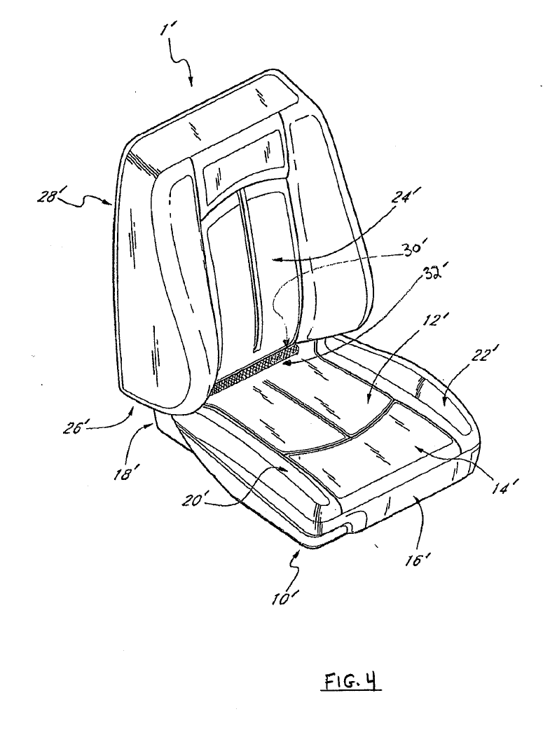

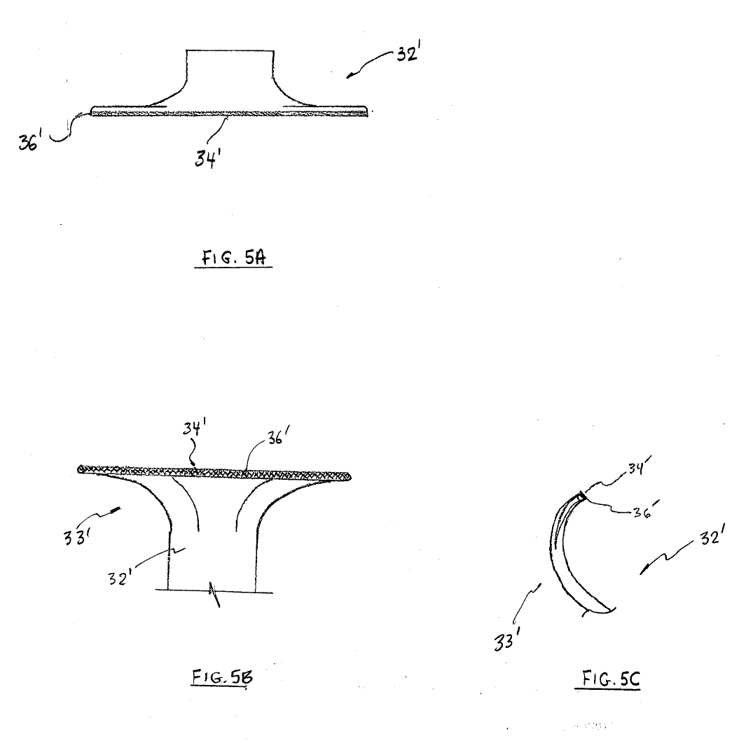

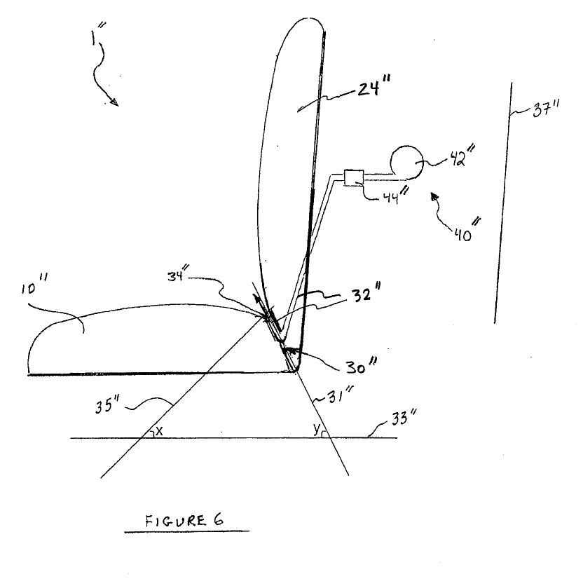

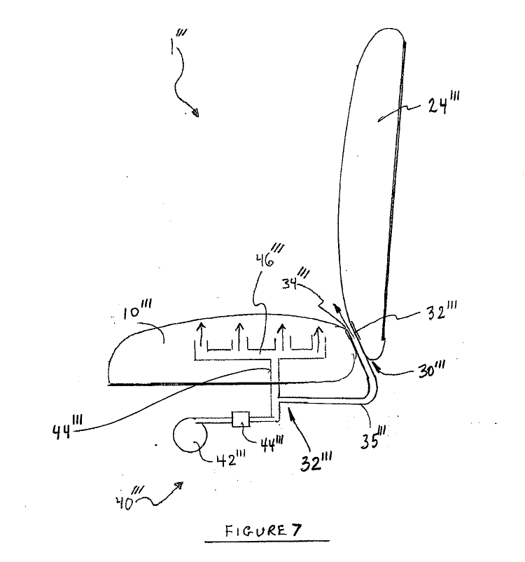

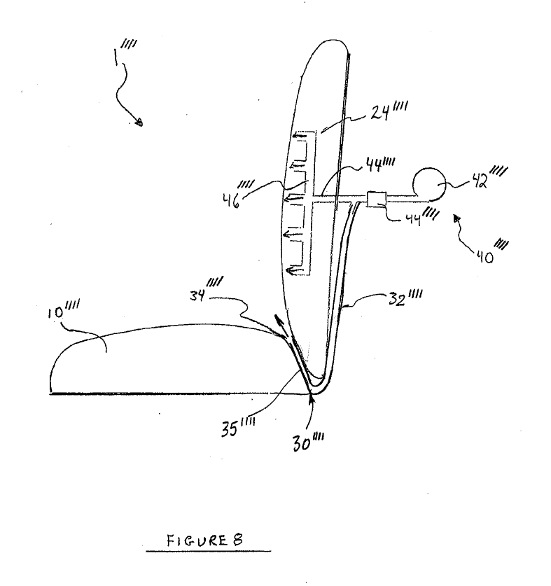

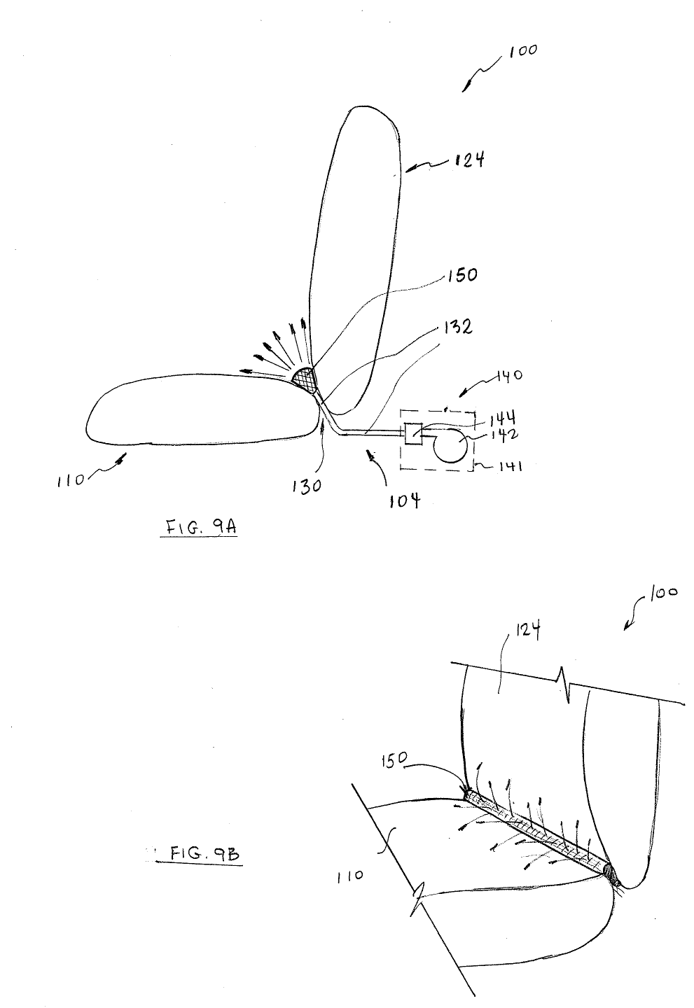

FIG. 4 illustrates one embodiment of a climate controlled vehicle seat 1′ that includes a fluid duct 32′ that terminates at or near the seat bite 30′. In addition, FIGS. 5A-5C illustrate various views of the fluid duct 32′ of FIG. 4. In the illustrated embodiment, the duct 32′ has a first end and a second end. At the first end, the duct 32′ can comprise a duct opening 34′. As shown, one or more duct openings 34′ can be located at or near the seat bite 30′ of the seat assembly 1′. Such duct openings 34′ can be shaped, sized and otherwise configured to form a generally flush and continuous surface with the seat bottom and seat back portions 10′, 24′. In other arrangements, the openings 34′ and/or other portions of the distal end of the fluid duct 32′ are generally not flush with the surfaces of the seat bottom and seat back portions 10′, 24′. For example, the openings 34′ and/or other portions of the distal end of the fluid duct 32′ can be recessed relative to the surfaces of the seat bottom and seat back portions 10′, 24′ (e.g., within the seat bite between the seat bottom and seat back portions 10′, 24′, but recessed from the front, exposed surfaces of such portions 10′, 24′.

In some embodiments, one or more duct openings 34′ or other duct outlets at the distal end of the fluid duct 32′ are selectively covered by one or more covers 36′ or other members. The duct cover 36′ can be configured to completely or partially hide and/or protect the fluid duct 32′. In some arrangements, the duct cover 36′ comprises a material that matches (e.g., in type, look, feel, texture, etc.) one or more materials used to cover the adjacent seat back portion and/or seat bottom portion of the seat assembly. Such duct covers can help ensure that personal effects of a seat occupant user, such as, for example, coins or the like, are not lost (e.g., by falling into the duct opening 34′). In addition, this can help eliminate or reduce the likelihood of damage to the various components of the climate control system (e.g., fluid transfer device, thermoelectric device, other components of the fluid module, etc.). For example, the duct cover 36′ can include a sheet of air permeable fabric, polymeric material and/or the like. In other arrangements, the cover 36′ comprises a material having a plurality of perforations or other openings through which air or other fluids may pass. As discussed in greater detail herein, the proximal or opposite end of the duct 32′ can be placed in fluid communication with one or more fluid modules (not shown) or other device configured to provide ambient and/or thermally conditioned fluid (e.g., air) toward a seated occupant.

In some embodiments, the duct 32′ comprises multiple duct openings 34′. Moreover, a seat assembly could include more than one duct 32′, as desired or required. Additionally, a single duct 32′ can be configured to temperature condition one, two or more seat assemblies 1′.

As discussed in greater detail herein, a seating assembly can include one or more climate control devices or systems. In some arrangements, such devices or systems comprise a heat transfer device as described in U.S. Pat. Nos. 6,223,539, 6,119,463, 5,524,439 and 5,626,021, all of which are hereby incorporated by reference herein in their entireties. In certain embodiments, the climate control device utilizes a Peltier circuit to selectively cool and/or heat air or other fluid being delivered through a fluid duct. An example of such a system is currently sold under the trademark Micro-Thermal Module™ by Amerigon Incorporated (Northville, Mich.). In other embodiments, a seat assembly comprises one or more other temperature conditioning devices, either in lieu of or in addition to a Peltier circuit. In alternative arrangements, a climate controlled seat assembly includes only a fluid transfer device without devices or features intended to temperature condition a fluid.

As disclosed herein, a climate control device can be configured to provide a heated or cooled fluid, a dehumidified fluid, a thermally-unmodified fluid (e.g., ambient air) and/or the like to one or more climate controlled seat assemblies. In one embodiment, a climate control device 44 is advantageously adapted to convectively heat and/or cool a fluid (e.g., air) and provide such a fluid to one or more desired portions of a seating assembly (e.g., automotive or other vehicle seat, a bed, wheelchair, another medical chair or bed, stadium seat, sofa, office chair, etc.). In other embodiments, a climate control device is generally configured to provide a fluid that is not temperature conditioned (e.g., ambient air) to one or more locations of the seating assembly. The thermal module or other portions of the climate control system can include other components or features to further condition the air or other fluids passing therethrough. For example, the system can include a fan, dehumidifier, filter and/or the like.

The fluid duct 32′ can have a different shape than illustrated in FIGS. 4 and 5A-5C or as otherwise disclosed herein. For example, the distal end 33′ of the duct 32′ can include one or more portions with less or greater curvature than illustrated in the embodiments of FIGS. 5A-5C. Further, the size, shape and/or other characteristics of the duct 32′ can vary, as desired or required for a particular application or use. In the illustrated configuration, the width or other cross-sectional dimension of the duct 32′ increases toward its distal end 33′ (e.g., at or near the openings or outlets 34′). Such an expansion or flaring of the duct 32′ can provide enhanced distribution of the air or other fluid being conveyed therein, thereby improving the comfort level to a seated occupant. However, in alternative embodiments, the width or other dimension of the duct 32′ can remain substantially constant or change in a different manner than illustrated in FIGS. 5A-5C.

According to some embodiments, the exact details of the fluid duct 32′ depend, at least in part, on the design and other characteristics of the seat assembly into or onto which the duct 32′ will be positioned, the configuration of the seat bite of such a seat assembly, the materials used and/or the like. With reference back to FIG. 4, the duct 32′ can extend continuously or substantially continuously across some, most or the entire seat bite area. However, in other arrangements, the duct 32′ is intermittently positioned within or near the seat bite of a seat assembly. Further, the fluid duct 32′ of the climate control system can extend across one or more smaller longitudinal portions of the seat bite line or area, as desired or required.

FIG. 6 demonstrates some of the additional benefits and features of the various arrangements disclosed herein. In the illustrated embodiment, the duct opening 34″ is not necessarily constrained by the geometry of the seat assembly 1″. For example, the duct opening 34″ can be situated such that a line parallel with the duct 32″ (generally represented by line 31″ in FIG. 6) approximately intersects a line parallel to the seat bottom portion 10″ (generally represented by line 33″). As shown, lines 31″ and 33″ can intersect so as to form an inside angle “y” that is less than 90 degrees. However, in other embodiments, the angle “y” can be equal to or greater than 90 degrees.

Likewise, in some embodiments, a line parallel to the exposed face of the duct opening 34″ (generally represented by line 35″ in FIG. 6) intersects a line 33″ that is substantially parallel to the seat bottom portion 10″ so as to create an angle “x” that is less than 90 degrees. As with angle “y”, in some embodiments, angle “x” can be equal to or greater than 90 degrees. Further, according to certain arrangements, each of angles “x” and “y” is between 0 and 90 degrees. For example, angle “x” and/or angle “y” can be 5, 10, 20, 30, 40, 50, 60, 70, 80, 85 degrees, or any angle between these values. Such configurations are not necessarily controlled by the geometry of the outside surface of the seat assembly 1″.

In some embodiments, a line 31″ parallel to the duct 32″ is generally angled relative to lines 33″, 37″, which in the illustrated arrangement are parallel or substantially parallel to the seat bottom 10″ and seat back portion 24″, respectively. Thus, the duct 32″ can be positioned at skewed angles relative to both the seat bottom 10″ and seat back portion 24″ of a seat assembly 1″. In alternate embodiments, however, the duct 32″ is parallel or substantially parallel to line 33″ and/or 37″, as desired or required by a particular application.

With reference to the embodiment schematically illustrated in FIGS. 7 and 8, a fluid duct of a climate control system can be in fluid communication with a plurality of channels that help comprise a fluid distribution system 46′″, 46″″ within a seat bottom and/or seat back portion of a seating assembly. Such a fluid distribution system 46′″ can be located in the seat bottom portion 10′″ (as shown in FIG. 7) and/or in the seat back portion 24″″ of the seat assembly (as shown in FIG. 8). Accordingly, one or more fluid modules 40′″, 40″″ can be placed in fluid communication with both the fluid duct 32′″, 32″″ and the fluid distribution system 46′″, 46″″. Alternatively, separate fluid modules 40′″, 40″″ can be used to selectively supply conditioned (e.g., heated, cooled, de-humidified, filtered, etc.) and/or unconditioned fluid (e.g., air) to the duct 32′″, 332″″, one or more fluid distribution systems 46′″, 46″″ and/or any other fluid distribution component included in the climate controlled seating assembly 1′″, 1″″.

With continued reference to FIG. 7, the duct 32′″ can be configured to provide fluid to both the fluid distribution system 46′″ (e.g., via a fluid distribution conduit 44′″) and the duct 35′″ that is configured to generally terminate near or extend through the seat bite 30′″ of the seat assembly 1′″. In some arrangements, one or more portions of the duct 32′″ (e.g., the fluid distribution conduit 44′″, the duct 35′″ in fluid communication with the seat bite 30′″ and/or the like) can positioned completely or partially within the seat bottom portion and/or the seat back portion of the seating assembly. Thus, some or all of the components of the climate control system can be generally interior of and/or exterior to the seat assembly, as desired or required. In other arrangements, the duct 32′″ is configured to pass through the seat bottom portion 10′″ or is configured to make up part of the seat bottom portion 10′″. As discussed herein with respect to other embodiments, the opening 34′″ of the fluid duct 35′″ can be positioned at or near the seat bite area 30′″ of the seating assembly 1′″.

Similarly, as illustrated in FIG. 8, the duct 32″″ can be in fluid communication with a fluid distribution system 46″″ located within, on and/or near the seat back portion 24″″ of the seat assembly 1″″. As discussed with reference to the embodiment of FIG. 7, the duct 32″″ can be configured to deliver air or other fluid from the fluid module 40″″ to both the seat bite area 30″″ (via duct 35″″) and to the channels, passages or other components of the fluid distribution system 46″″ positioned within or on the seat back portion 24″″ (via a fluid distribution conduit 44″″). Alternatively, the duct 32″″ and its various branches can be fully or partially integrated into the seat assembly. As discussed herein, the opening 34″″ along a distal end of the fluid duct 35″″ can be positioned at or near the seat bite 30″″ of the seating assembly 1″″. However, a climate controlled seat assembly can include one or more other duct openings, either in lieu of or in addition to the duct opening 34″″ located along the distal end of the duct 35″″ at or near the seat bite. Such duct openings can be located at the distal end of a duct and/or along one or more intermediate locations.

With continued reference to FIGS. 7 and 8, one or more fluid ducts 35′″, 35″″ providing ambient and/or thermally-conditioned air to and/or through the seat bite area of a seat assembly can be used in conjunction with a fluid distribution system 46′″, 46″″ situated on or within the seat bottom and/or seat portions. However, such ducts 35′″, 35″″ can be used in lieu of any fluid distribution systems 46′″, 46″″. A fluid distribution system 46′″, 46″″ can comprise one or more channels, passages, recesses or other portions through which fluids may be selectively directed. In some arrangements, inserts, fluid distribution devices, fluid diverters and/or any other item, component or feature are included within a fluid distribution system in order to achieve a desired effect. According to some embodiments, a single fluid module 40′″, 40″″ (e.g., fluid transfer device 42′″, 42″″, thermoelectric device 4′″, 44″″, etc.) is used to deliver conditioned and/or unconditioned fluid (e.g., air) to both the duct 35′″, 35″″ that transfer such fluid to, near or through the seat bite and to one or more fluid distribution systems 46′″, 46″″. However, in other embodiments, air or other fluid can be supplied to each duct and/or fluid distribution system using a different fluid module, as desired or required.

According to certain arrangements, fluid ducts configured to selectively deliver air or other fluids to fluid distribution systems and/or outlet openings located at or near the seat bite of a seat assembly can share, at least partially, one or more conduits, valves and/or any other component of a climate control system. In some embodiments, the fluid losses or flow resistance from the fluid module to the outlets of a seat bite duct can be greater than, less than or equal to the fluid losses or flow resistance through a fluid distribution system (e.g., channels or passages formed within or on the seat back and/or seat bottom portions, inserts situated therein, etc.). Further, an interior cross-sectional dimension (e.g., diameter, width, other dimension, etc.) of a fluid duct 35′″, 35″″ configured to deliver air to or through the seat bite of the duct 32′″, 32″″ is smaller than, equal to or greater than an interior cross-sectional dimension of a channel, passage, recess or other opening formed onto or within a seat assembly as part of the fluid distribution system 46′″, 46″″.

FIGS. 9A and 9B schematically illustrate another embodiment of a climate controlled seat assembly 100 equipped with a climate control system 104, which is configured to selectively deliver thermally-conditioned and/or ambient air to a seated occupant. In the depicted arrangement, the climate control system 104 comprises a fluid conduit or duct 132 that places a fluid module 140 in fluid communication with a fluid distribution member 150 positioned at or near the seat bite 130. As discussed herein with reference to other embodiments, the fluid module 140 can include a fluid transfer device 142 (e.g., a blower, fan, etc.) for transferring air or other fluids toward a seated occupant through the downstream conduit 132 and distribution member 150. Advantageously, the fluid transfer device 142 can be sized and otherwise configured to deliver a volume of air or other fluid through the climate control system 104 at a desired flowrate. In some embodiments, as discussed in greater detail herein, the rate of delivery of air or other fluids through the climate control system can be automatically or manually adjusted by a user.

The fluid module 140 can additionally include a thermoelectric device 144 (e.g., Peltier circuit) or another thermal conditioning device configured to selectively heat and/or cool air or other fluids passing through the module 140. As with the fluid transfer device 142, one or more aspects related to the operation of the thermoelectric device 144 can be selectively modified to achieve a desired level of cooling and/or heating to the fluid exiting the fluid module 140. Relatedly, the fluid module 140 and/or other portions of the climate control system 104 can comprise one or more sensors (e.g., temperature sensors, humidity sensors, occupant detection sensors, etc.), timers, controllers and/or other devices or components that can further assist in controlling the operation of the climate control system 104 in a desired or required manner.

In any of the embodiments disclosed herein, or variations thereof, the fluid transfer device 142, the thermoelectric device 144, one or more sensors and/or other components of the climate control system 104 can be positioned within a single housing 141 or other enclosure. This can facilitate the manufacture, delivery, installation or other aspects associated with providing, installing and maintaining the climate control system 104.

According to certain arrangements, the conduit 132 that places the fluid module 140 in fluid communication with the distribution member 150 is at least partially flexible to permit the fluid module 140 and the distribution member 150 to be located as desired or required. However, in other configurations, the conduit 132 is rigid or semi-rigid, thereby limiting the ability to move or re-position the components attached thereto (e.g., fluid module 140, fluid distribution member 150, etc.). The fluid conduit or duct 132 can comprise a flexible, rigid and/or semi-rigid material, as desired or required. For example, the conduit can include one or more polymeric materials, metals, rubber and/or the like.

With continued reference to FIGS. 9A and 9B, the distribution member 150 can be configured to receive fluid from the conduit 132 and selectively distribute it toward a seated occupant. In some embodiments, as shown in FIG. 9B, the distribution member 150 continuously extends across most or the entire width of the seat bite 130. However, the distribution member 150 can extend over a smaller portion of the seat bite 130, as desired or required. Further, the distribution member 150 can intermittently extend along the seat bite 130. In some arrangements, the distribution member 150 comprises a spacer material (e.g., a spacer fabric), a porous or air permeable structure and/or any other item that is configured to help distribute air or other fluid being directed from the fluid module. The distribution member 150 can include an air-permeable or porous outer surface through which air or other fluids can exit toward a seated occupant.

The distribution member 150, the fluid conduit 132 and/or other components of the climate control system 104 can be sized, shaped and otherwise configured to securely remain at or near the seat bite area 130 of a seat assembly 100. For instance, in certain arrangements, the distribution member 150 and the distal end of the fluid duct 132 are adapted to be advantageously maintained within the seat bite 130 by the squeezing force created by the adjacent surfaces of the seat back portion 124 and the seat bottom portion 110.

As illustrated in FIG. 9A, the distribution member 150 can extend, at least partially, beyond the seat line 130 toward the front surface of the seat assembly 100. Thus, in some arrangements, the distribution member 150 is not generally flush with the exposed surfaces of the seat bottom and seat back portions 110, 124. Alternatively, the climate control system 104 can be configured so that a distal surface of the distribution member 150 is generally flush with the seat bottom and seat back portions 110, 124 of the assembly when the climate control system 104 is properly secured thereto. According to certain embodiments, as shown in FIG. 9A, the distribution member 150 is flared or otherwise has an expanding profile in order to prevent it from inadvertently passing (e.g., rearwardly) through the seat bite 130 during use.

In any of the embodiments disclosed herein, a fluid module can be configured to draw air or other fluids away from the occupant, effectively reversing the direction of flow through the climate control system. In such arrangements, the climate control system can help ventilate the air surrounding the front surfaces of the seat assembly that generally surrounds a seated occupant.

Another embodiment of a climate control system 204 configured to be used with a seat assembly 200 is illustrated in FIGS. 10A and 10B. As with other configurations disclosed herein, the climate control system 204 can include a fluid module 240 that is adapted to selectively transfer air or other fluids to or from the front surface seat assembly 200. The fluid module 240 can include a fluid transfer device 242 (e.g., fan, blower, etc.), a thermoelectric device 244 (e.g., Peltier circuit) or other thermal conditioning device and/or any other component. As shown in FIG. 10A, a fluid conduit 260 can be used to place the fluid module 240 in fluid communication with one or more surfaces along the front of the seat assembly 200 against which a seated occupant will be positioned.

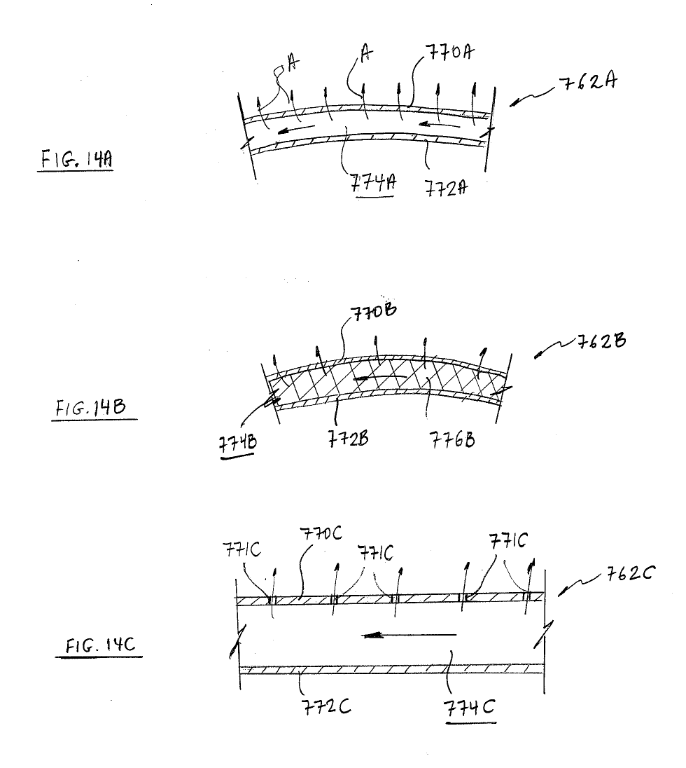

According to certain embodiments, as illustrated in FIG. 10A, the fluid duct 260 can be routed through the seat bite 230 of the seat assembly. The fluid duct 260 can branch off into two or more separate fluid chambers 262, 266 or pads along the front surfaces of the seat assembly 200. As shown, a lower fluid chamber 262 or pad can generally extend along the top surface of the seat bottom portion 210 of the seat assembly 200. Likewise, an upper fluid chamber 266 or pad can generally extend along the front surface of the seat back portion 224. In some arrangements, the fluid chambers 262, 266 comprise an air permeable material and/or a porous surface through which air or other fluids can exit in the general direction of a seated occupant. As discussed in greater detail herein with reference to FIGS. 14A-14C, the fluid chambers or pads 262, 266 can include fabric, polymeric materials and/or the like. In other embodiments, the fluid chambers or pads 262, 266 include a non-air permeable material that comprises a plurality of openings (e.g., pores) through which fluids may exit.

The size, shape and other characteristics of the climate control system 204 can be customized, as desired or required by a particular application or use. For example, in the embodiment illustrated in FIGS. 10A and 10B, the fluid chambers 262, 266 extend only partially across the front surfaces of the seat bottom and seat back portions 210, 224 of the seat assembly 200. However, in alternative arrangements, the dimensions of the fluid chambers 262, 266 or pads can be greater or smaller than depicted in FIGS. 10A and 10B. For instance, the fluid chambers 262, 266 can be wider to cover most or all of the width of seating assembly 200. Further, the length of the lower fluid chamber 262 and/or the upper fluid chamber 266 can be modified to cover more or less of the seat bottom portion 210 and/or the seat back portion 224, respectively.

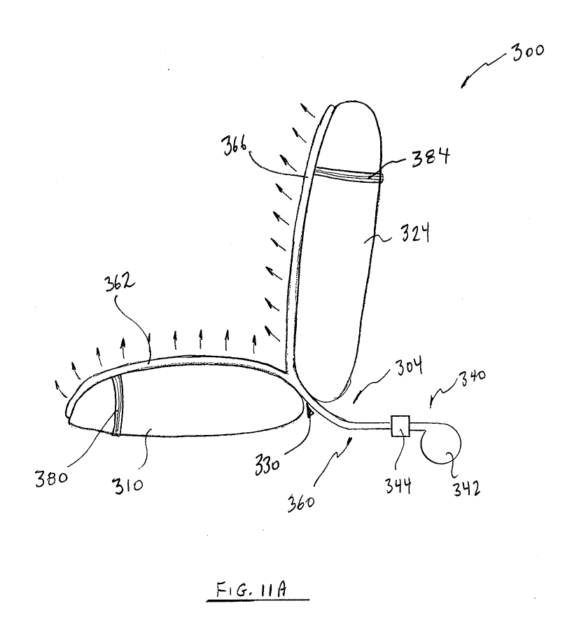

One embodiment of a climate control system 304 comprising fluid chambers 362, 366 that extend over a larger area of a seat assembly 300 is illustrated in FIG. 11A. In the depicted arrangement, the lower fluid chamber 362 or pad covers substantially the entire length of the top surface of the seat bottom portion 310. Likewise, the upper fluid chamber 366 or pad can be sized, shaped and otherwise configured to cover substantially the entire length of the front surface of the seat back portion 324. Accordingly, in such a configuration, the fluid module 340 can be configured to selectively transfer air or other fluids to and/or from a larger area of the front surface of the seat assembly 300. As discussed with reference to the climate control system of FIGS. 10A and 10B, the fluid chambers 362, 366 can be placed in fluid communication with a fluid transfer device 342, a thermoelectric device 344 and/or any other component of a fluid module 340 using one or more fluid ducts 360. In the depicted embodiment, the fluid duct 360 is configured to be routed through the seat bite 330 of the seat assembly.

Another embodiment of a climate control system 404 adapted to be used with a seat assembly 400 is illustrated in FIG. 11B. As shown, the climate control system 404 can include only an upper fluid chamber or pad 466. Thus, with such a system 404, air or other fluids can be transferred only to and/or from the seat back portion 424 of the seat assembly 400. Alternatively, the climate control system 404 can be configured to provide a fluid chamber or pad only along the seat bottom portion. Regardless of the exact configuration of the fluid chambers 466, the climate control system 404 can include a duct 460 that is sized, shaped and otherwise adapted to pass through or near the seat bite 430 of the seat assembly 400. As shown, such a duct 460 can advantageously place the fluid chamber 466 in fluid communication with a fluid module 440.

In any of the embodiments disclosed herein, or equivalents thereof, the fluid chambers or any other member or component that is configured to be positioned along a front surface of a seating assembly can be maintained in a desired orientation using one or more attachment methods or devices. For example, as illustrated in FIG. 11A, straps 382, 384 can be used to help maintain the corresponding fluid chambers 362, 366 along the front surfaces of the seat assembly 300. Such straps or other devices can include elastic or other resilient materials that are configured to be selectively stretched at least partially around the seat bottom and/or seat back portions 310, 324, as desired or required. In other arrangements, the fluid chambers are secured against the front surfaces of a seat assembly using hook and strap connections (e.g., Velcro®), buttons, zippers, other fasteners, adhesives and/or the like. Alternatively, the fluid chambers can be adapted to remain against the adjacent surfaces of the seat assembly without the need for attachment devices. For example, in some embodiments, a fluid chamber is configured to remain against an adjacent surface of the seat bottom and/or seat back portion of the seat assembly using the contacting force of a seated occupant. The fluid chambers or pads can include a non-skid surface to help reduce the likelihood of movement relative to adjacent seating assembly surfaces.

FIGS. 12A and 12B illustrate another embodiment of a climate control system 504 configured for use with a seating assembly 500 (e.g., an automotive seat, other vehicle seat, a bed, etc.). The depicted arrangement has a similar design as the system of FIGS. 10A, 10B and 11A, in that it includes a fluid module 540 and a duct 560, which places the module 540 in fluid communication with fluid chambers or pads 562, 566 positioned against the front surfaces of the seat bottom and seat back portions 510, 524. The climate control system 504 additionally comprises a main outlet 534 at or near the seat bite 530 of the seat assembly 500. Thus, in such an embodiment, air or other fluid can be selectively transferred to or from the fluid module 540 through both the air-permeable or porous surface of the fluid chambers 562, 566 and the main outlet 534 located at or near the seat bite 530. In other arrangements, a climate control system can include additional outlets along one or more desired locations.

In some of the embodiments disclosed herein, such as, for example, those illustrated in FIGS. 3A, 3C, 9A-9B, 10A-10B, 11A-11B and 12A-12B, the ducts, fluid chambers and/or other components that are placed in fluid communication with a fluid module are configured to be positioned along exterior surfaces of the seat bottom and/or seat back portions of a seat assembly. This can facilitate the positioning of such systems on a vehicle seat or other seat assembly, as the need to modify an interior of the seat cushions or other portions of the seat assembly is eliminated. Accordingly, such climate control systems can be conveniently installed on a seating assembly as after-market items without the need to modify the structure or other aspects of the seat assembly design. For example, with specific reference to the system 304 of FIGS. 11A and 11B, a user can pass the fluid chambers or pads 362, 366 through the seat bite area 330 of the seat assembly 300. As a result, the fluid chambers 362, 366 can be positioned along the front surfaces of the seat assembly 300, while the fluid module 340 and at least part of the fluid duct 360 remain along a rear and/or bottom portion of the assembly 300 (e.g., generally away from a seated occupant). One or more straps 382, 384 and/or other attachment devices or methods can be used to adequately maintain the fluid chambers 362, 366 along the adjacent surfaces of the seat bottom and seat back portions 310, 324.

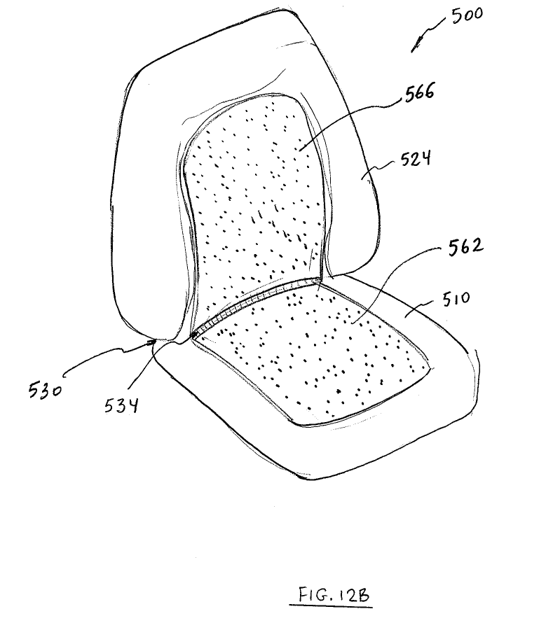

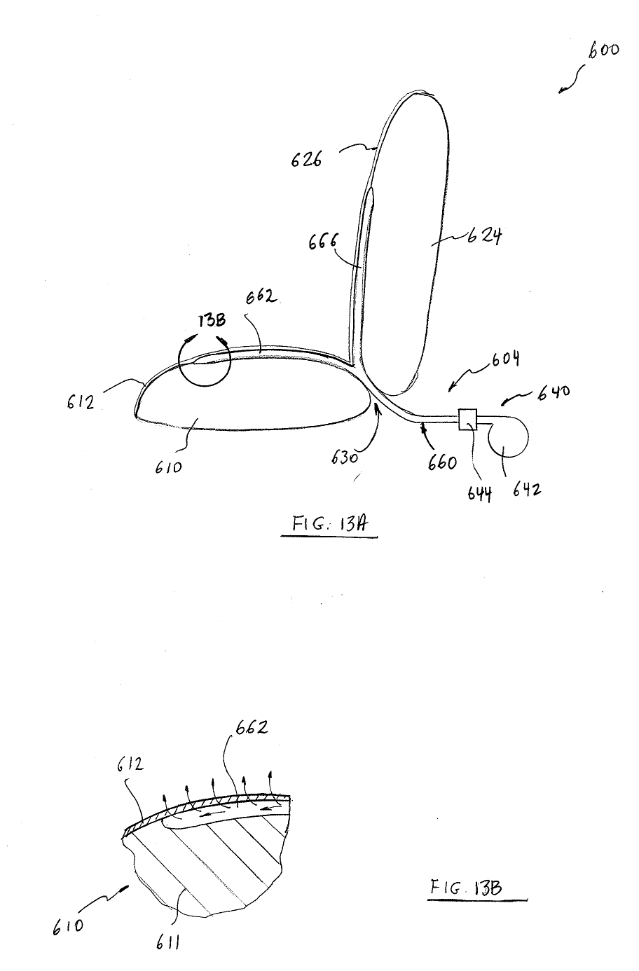

FIGS. 13A and 13B illustrate one embodiment of a climate control system 604 that is configured to be at least partially situated underneath one or more layers or portions of the seat assembly 600. As with other arrangements illustrated and described herein, the depicted system 604 comprises a fluid duct 660 which is in fluid communication with a fluid module 640 and which is configured to be routed through or near the seat bite 630 of the seating assembly 600 (e.g., generally between the seat bottom and seat back portions 610, 624). However, as shown in FIGS. 13A and 13B, along the front surface of the seating assembly 600, the duct or conduit 660 can be connected to two or more fluid chambers or pads 662, 666 that are positioned underneath a covering layer or scrim 612, 626 of the seat back and/or seat bottom portions 610, 624. Thus, the fluid chambers 662, 666 can be situated within an interior portion of the seat assembly 600 so as to not be visible to a seated occupant.

With continued reference to FIGS. 13A and 13B, the fluid chambers or pads 662, 666 and/or other portions of the climate control system 604 can be positioned between adjacent layers or portions of the seat assembly's interior (e.g., cushion 611, covering layer or scrim 612, etc.). Alternatively, the fluid chambers or pads 662, 666 can be sized, shaped and otherwise adapted to be positioned within recesses or other portions of the cushion 611 and/or other interior structure of the assembly 600, as desired or required.

Regardless of its exact configuration, such a climate control system 604 can advantageously deliver thermally conditioned and/or ambient air from the fluid module 640 (e.g., fluid transfer device 642, thermoelectric device 644, etc.), through the duct 660 and fluid chambers 662, 666, toward a seated occupant. Alternatively, as with any other arrangements disclosed herein, fluid flow through the climate control system 604 can be generally reversed, so that air or other fluids are transferred away from the front surfaces of the seating assembly by the fluid module 640. Such embodiments can also be provided as after-market items that can be installed on a vehicle seat or other seat assembly which has already been manufactured. However, because portions of the system 604 (e.g., fluid chambers 662, 666, duct 660, etc.) may need to be positioned within an interior portion of the seat bottom and/or seat back portions 610, 624 of the seat assembly 600, the installation of such systems 604 may be more intricate.

FIGS. 14A-14C illustrate partial cross-sectional views through various embodiments of fluid chambers or pads 762A, 762B, 762C that can be used with a climate control system as disclosed herein. As shown in FIG. 14A, the fluid chamber or pad 762A can include an interior space 774A defined by upper and lower walls 770A, 772A. The walls 770A, 772A of the chamber or pad 762A can include one or more substantially air-permeable and/or substantially air-impermeable materials. For example, in some arrangements, the walls 770A, 772A comprise fabric, polymeric materials (e.g., plastic sheets or bags), elastomeric materials, paper-based materials and/or the like. Such materials can be, at least in part, air or fluid-permeable so that air or other fluids directed within an interior portion 774A of the chamber 762A are allowed to exit through the upper wall 770A and/or the lower wall 772A, as desired or required. In other embodiments, the upper and/or lower walls 770A, 772A comprise a plurality of openings (e.g., pores) through which air or other fluids may pass (FIG. 14C).

As illustrated in FIG. 14B, the interior 774B of a fluid chamber or pad 762B can include a spacer material or other structure 776B. Such spacer materials or structures 776B can help maintain a desired shape for the interior space 774B, especially after the climate control system has been placed into service (e.g., after it has been subjected to contact and other forces by a seated occupant). In addition, such spacer materials 776B can help distribute fluids more evenly within an interior portion 774B of the fluid chamber 762B, thereby providing an enhanced cooling, heating and/or ventilation effect to a seated occupant. Any of the embodiments of a climate control system or device disclosed herein, or equivalents thereof, can comprise one or more spacer materials or structures 776B, as desired or required.

FIG. 14C illustrates one embodiment of a fluid chamber or pad 762C that comprises substantially air-impermeable walls 770C, 772C. Thus, as discussed above, such a fluid chamber 762C can include a plurality of pores or other openings 771C along one or both walls 770C, 772C in order to permit air or other fluids to exit from the chamber's interior space 774C.

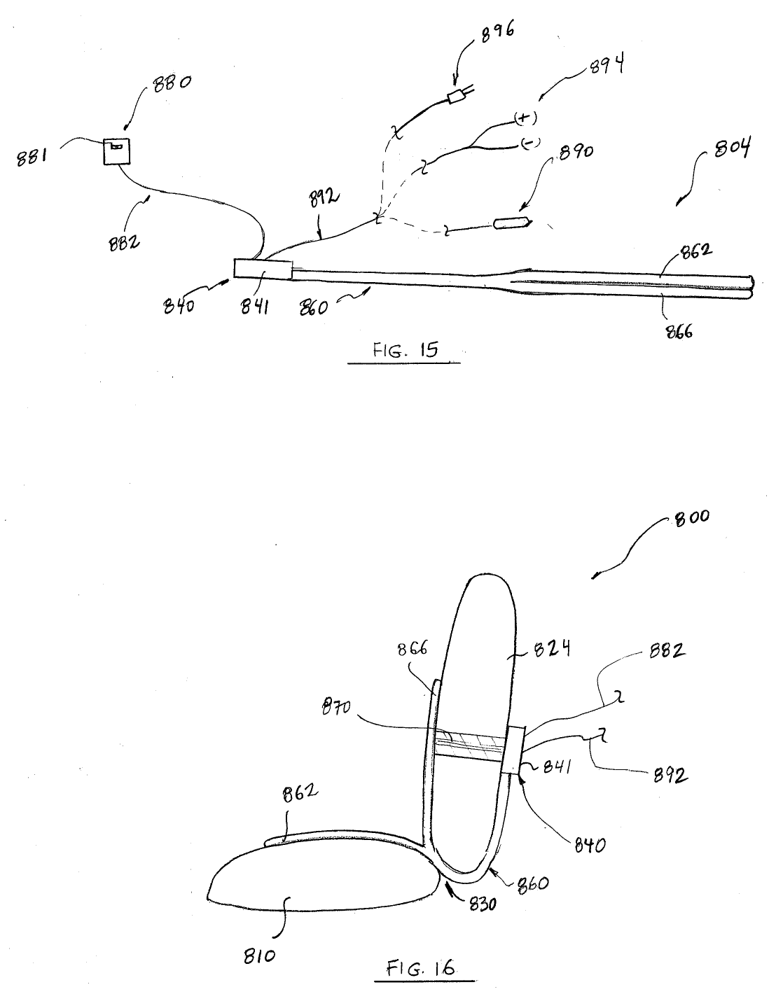

Another embodiment of a climate control system 804 configured for use with a vehicle seat 800 or other seating assembly is illustrated in FIGS. 15 and 16. As discussed above, the climate control system 804 can be provided as an after-market product that can be easily and conveniently installed on a seating assembly 800. Alternatively, a system 804 can by incorporated into a seating assembly by a manufacturer, assembler, dealer, installer and/or other party either prior to, during or after the manufacture of the seating assembly.

With continued reference to FIGS. 15 and 16, the climate control system 804 can include a fluid module 840, which, according to some embodiments, comprises a fluid transfer device (e.g., a fan, blower, etc.), a thermoelectric device (e.g., Peltier circuit) or other heating and/or cooling device, sensors, controllers, filters and/or the like. In certain arrangements, the various components of the fluid module 840 are provided within a single housing 841 or other enclosure. This can simplify the overall design of the system 804 and further facilitate its installation onto a seat assembly 800. However, in alternative embodiments, the various components of the fluid module are provided outside of a housing or in two or more separate housings or enclosures, as desired or required.

As illustrated in FIG. 15, the fluid chambers or pads 862, 866 can be routed from the rear side to the front side of the seat assembly 800 through the seat bite area 830. In addition, the fluid module 840 and the fluid duct or conduit 860 can be positioned along a rear surface of the seat back portion 824. However, in other arrangements, the module 840 and/or the duct 860 can be positioned at any other location, such as, for example, underneath the seat bottom portion 810, away from the seat assembly 800 and/or the like, as desired or required. As discussed herein, the position of one or more of the fluid chambers or pads 862, 866 relative to an adjacent surface of the seat assembly 800 can be maintained in a desired orientation using one or more straps 870, hoop and loop fasteners, buttons, zippers, other fasteners, adhesives and/or any other attachment device or method. According to some embodiments, after installation, the climate control system 804 can be easily removed from a seating assembly 800 for cleaning, repair, maintenance, transfer to another seating assembly and/or for any other purpose.

With continued reference to FIGS. 15 and 16, the climate control system 804 can include a wire, cable or cord 892 that is adapted to provide electrical power to the fluid transfer devices, thermoelectric devices, sensors, controllers and/or any other component of the fluid module 840 and/or other portion of the system 804. As shown, in certain embodiments, the power cord 892 includes a cigarette lighter adapter 890 or other standard or non-standard adapter that is configured to connect to a vehicle's electrical system (e.g., via a cigarette lighter port, some other standard or non-standard AC or DC power outlet or port, etc.). In embodiments where the climate control system is adapted to be used with an office chair, bed, sofa, wheelchair, other medical chair or bed and/or any other seating assembly, the system can be configured to be powered using a standard or non-standard AC or DC outlet (e.g., a standard wall outlet). Thus, the system can include one or more cords 892, plugs 896, other adapters, transformers and/or any other items to help provide the necessary electrical power to the fluid module and/or its other electrical components. As discussed in greater detail below, such climate control systems can include one or more batteries (e.g., rechargeable batteries) so that the systems do not need to be physically connected (e.g., via a wire, cord, cable, etc.) to a power supply while the climate control system and the seating assembly are occupied or being used.

Alternatively, the various electrical components of the climate control system can be powered using one or more other power sources, such as, for example, a battery, a solar panel and/or the like, either in addition to or in lieu of other AC or DC sources. For example, the system can include a battery within, on, near and/or operatively connected to the fluid module 840 and/or any other component. Such batteries can be configured to provide the desired electrical power to the various electrical components. In some embodiments, the battery is rechargeable to permit the climate control system or device to operate for a particular time period without being physically connected to a separate power supply (e.g., wall or automotive outlet via a cord). Such a rechargeable battery can include a standard or non-standard adapter configured to attach to an AC or DC power outlet (e.g., a wall outlet or other standard home power outlet, a cigarette or other automotive power outlet, a solar panel and/or the like). As illustrated in FIG. 15, in other arrangements, the climate control system is linked to the vehicle's main electrical system 894 using a hardwired connection that is not easily detachable.

According to certain embodiments, the fluid module 840 and/or any other portion of a climate control system 804 can comprise a controller 880 using a hardwired 882 and/or wireless (e.g., radio frequency, Bluetooth, etc.) connection. The controller 880 can include a switch 881, dial, button and/or other device that is capable of adjusting one or more aspects of the operation of the climate control system 804. For example, in some embodiments, the controller 880 is adapted to regulate the flowrate of the fluid transfer device and/or the cooling or heating effect created by the thermoelectric device. In other arrangements, one or more other aspects of the climate control system 804 can be adjusted, as desired or required. In yet other embodiments, the system 804 includes one or more sensors (e.g., temperature sensors, humidity sensors, occupant detection sensors, etc.), feedback loops and/or other control devices or features in one or more of its components or portions (e.g., fluid module 840, interior portion of the duct 860 and/or fluid chambers 862, 866, etc.). Such features can be configured to allow the climate control system 804 to operate automatically or semi-automatically in order to achieve a desired cooling, heating and/or ventilation effect (e.g., to sustain a desired flowrate toward an occupant, to maintain a desired temperature and/or the like). However, in other embodiments, the climate control system 804 is configured to be operated manually by a user. The power supply and control features discussed herein with reference to FIGS. 15 and 16 are equally applicable to all other embodiments discussed and/or illustrated herein, or equivalents thereof.

As discussed, in any of the embodiments disclosed herein, or equivalents thereof, one or more fluid modules can be used to selectively deliver thermally-conditioned and/or unconditioned air or other fluid to a fluid duct, distribution members or systems, fluid chambers or pads and/or any other downstream components. In other embodiments, conditioned and/or unconditioned fluid is delivered to one or more other portions of the seating assembly, such as, for example, the neck portion, the lower legs and/or the like.

In some embodiments, a volume of conditioned and/or unconditioned fluid can be delivered to the seat bite line area of a seat assembly and/or downstream fluid chambers or pads, either in lieu of or in addition to providing fluid to one or more fluid distribution systems located within the seat bottom portion and/or seat back portion. Such methods of providing fluids can include providing a fluid duct at a seat bite line which may be formed at or near a juncture between a seat bottom and a seat back in a vehicle seat (e.g., at or near the seat bite). In some embodiments, the method further includes maintaining a fluid module in fluid communication with the duct. The method can additionally comprise conditioning a fluid using a fluid module and providing the conditioned fluid from the fluid module to the duct. However, it will be appreciated that unconditioned fluids (e.g., ambient air) can be delivered to a fluid duct and/or a fluid distribution system (e.g., an insert or channels positioned within the seat back and/or seat bottom portions of the seat assembly).

In any of the arrangements disclosed herein, a seat assembly having a seat bottom portion and a seat back portion comprises a fluid duct with a duct opening at or near the seat bite line. As discussed, the fluid duct can be placed in fluid communication with a fluid module to selectively deliver conditioned and/or unconditioned fluid to one or more portions of the seating assembly. The fluid module can include a climate controlled device that is adapted to selectively create one, two or more streams of conditioned fluid (e.g., cool or warm air, dehumidified air, etc.). Further, the fluid module can be configured to provide a stream of conditioned fluid to one or more duct openings through at least a portion of a duct body. In some arrangements, the fluid module provides a second stream of conditioned fluid to different area through a different duct and/or a different passage of the same duct. The second area could be, for example, an area near an occupant's feet, thighs, neck, head, arms, shoulders and/or the like. Thus, a complementary heating and cooling effect can be simultaneously created on various portions of a seat occupant's body.

In the various embodiments disclosed herein, or equivalents thereof, a fluid duct is configured to deliver a volume of conditioned and/or unconditioned fluid (e.g., air) towards one or more areas of an occupant's anatomy that generally do not contact the seat assembly, such as, for example, the occupant's lower back. In contrast, the prior art describes various climate controlled seat assemblies in which air is delivered to portions of the seat assembly that generally contact an occupant's body, such as the main areas of the seat back and seat bottom portions. By directing conditioned and/or unconditioned fluid to an occupant's lower back and/or other portions of the occupant's anatomy that generally do not contact the seat assembly, the effect of the fluid can provide a desirable cooling and/or heating effect. In addition, as discussed, positioning fluid ducts and duct openings as disclosed by the various embodiments herein, or equivalents thereof, can facilitate the manufacture, assembly and other aspects of creating a climate controlled seat assembly. Further, in some embodiments, such ducts can help reduce the complexity and cost of producing and/or assembling climate controlled seats.

As discussed with respect to certain embodiments disclosed herein, the use of ducts to deliver air or other fluid to portions of an occupant's back that generally do not contact the seat assembly can be used in lieu of or in combination with the use of designs that are configured to deliver fluid to areas of the seat assembly with which an occupant generally contacts (e.g., using inserts, channeled cushions, etc.).

The embodiments of the fluid modules and/or the climate controlled seating assemblies described and/or illustrated herein can comprise a thermoelectric device for temperature conditioning (e.g., selectively healing and/or cooling) the fluid flowing through the device. A thermoelectric device can include a Peltier thermoelectric module, which is well known in the art. Such devices typically include a main heat exchanger for transferring or removing thermal energy from the fluid flowing through the device and to the distribution systems. Typically, such devices also include a secondary (or waste) heat exchanger that extends from the thermoelectric device generally opposite the main heat exchanger. A single fluid transfer device can be used to direct fluid over, through or in the vicinity of the main and/or waste heat exchangers for temperature conditioning purposes. In alternative embodiments, two or more fluid transfer devices can be used to move air or other fluid relative to the heat exchangers. For example, one fluid transfer device can be configured to convey air past the main heat exchanger while a second fluid transfer device can be configured to convey air past the waste heat exchanger.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof. In addition, while the number of variations of the inventions have been shown and described in detail, other modifications, which are within the scope of this inventions, will be readily apparent to those of skill in the art based upon this disclosure. It is also contemplated that various combinations or subcombinations of the specific features and aspects of the embodiments may be made and still fall within the scope of the inventions. Accordingly, it should be understood that various features and aspects of the disclosed embodiments can be combined with, or substituted for, one another in order to perform varying modes of the disclosed inventions. Thus, it is intended that the scope of the present inventions herein disclosed should not be limited by the particular disclosed embodiments described above, but should be determined only by a fair reading of the claims.

What is claimed is:

1. A climate control device for use with a seating assembly, said climate control device comprising:
a fluid module comprising a fluid transfer device;
a fluid duct in fluid communication with the fluid module, said fluid duct comprising a distal end; and
at least one outlet opening positioned at the distal end of the fluid duct;
wherein the fluid duct is configured to be positioned at or through a seat bite area of the seating assembly; and
wherein the fluid module is configured to selectively transfer air to or from the at least one outlet opening through the fluid duct.

2. The climate control device of claim 1, wherein the fluid module further comprises a thermoelectric device configured to selectively thermally condition air being transferred through the fluid duct.

3. The climate control device of claim 1, wherein the distal end of the fluid duct generally terminates at or near the seat bite of the seat assembly.

4. The climate control device of claim 3, further comprising a fluid distribution member positioned at the distal end of the fluid duct, said fluid distribution member configured to help distribute air from the fluid duct toward an occupant seated in the seating assembly.

5. The climate control device of claim 1, wherein the distal end of the fluid duct generally extends through the seat bite of the seat assembly.

6. The climate control device of claim 5, further comprising at least one fluid chamber disposed along at least one of a seat back portion or a seat bottom portion of the seating assembly;
wherein said at least one fluid chamber comprises a first surface adapted to be positioned against a front surface of the seat back portion or the seat bottom portion and a second surface generally opposite of the first surface;
wherein said at least one fluid chamber is configured to permit air to pass through said second surface toward a seated occupant; and
wherein the fluid module is configured to selectively transfer air to or from the fluid chamber, through the fluid duct.

7. The climate control device of claim 6, wherein the at least one fluid chamber is configured to be positioned along an exterior of the seat back portion or the seat bottom portion.

8. The climate control device of claim 6, wherein the at least one fluid chamber is configured to be positioned along an interior of the seat back portion or the seat bottom portion.

9. The climate control device of claim 1, wherein the climate control device is an after-market device configured to be installed on a completed seating assembly.

10. The climate control device of claim 1, further comprising a cover generally positioned along the at least one outlet opening to prevent objects from falling through said at least one outlet opening.

11. The climate control device of claim 1, further comprising a power adapter configured to be selectively inserted within a power outlet to supply electrical power to the fluid module.

12. The climate control device of claim 11, wherein the power adapter is configured to be inserted into a standard power outlet.

13. The climate control device of claim 1, further comprising a controller configured to regulate at least one operational aspect of the fluid module.

14. A climate control system configured to be removably installed on a seating assembly, said climate control system comprising:
a fluid module comprising a fluid transfer device and a thermoelectric device;
a fluid duct in fluid communication with the fluid module and the thermoelectric device, said fluid duct configured to be routed through a seat bite area of a seating assembly; and
at least one fluid chamber configured to be disposed along at least one of a seat back portion or a seat bottom portion of the seating assembly;
wherein the at least one fluid chamber comprises walls that define an interior space, said interior space being in fluid communication with the fluid duct;
wherein at least a portion of the walls of the fluid chamber is configured to be air-permeable;
wherein the fluid module is configured to selectively transfer air through the fluid duct and the at least one fluid chamber, through the at least a portion of the walls of the fluid chamber that is air-permeable; and
wherein the thermoelectric device is configured to selectively heat or cool air being transferred by the fluid transfer device.

15. The climate control system of claim 14, wherein the at least one fluid chamber is configured to be positioned along an exterior of the seat back portion or the seat bottom portion.

16. The climate control system of claim 14, wherein the at least one fluid chamber is configured to be positioned along an interior of the seat back portion or the seat bottom portion.

17. The climate control system of claim 14, wherein the at least one fluid chamber comprises a spacer material.

18. The climate control system of claim 14, wherein the fluid module is configured to be secured along a rear side of the seat back portion or along a bottom side of the seat bottom portion.

19. The climate control system of claim 14, wherein the climate control system is an after-market device configured to be installed on a completed seating assembly.

20. The climate control system of claim 14, wherein the seating assembly comprises a seat.

21. The climate control system of claim 14, wherein the seating assembly comprises a bed.

22. The climate control system of claim 14, further comprising a power adapter configured to be selectively inserted within a power outlet to supply electrical power to the fluid module.

23. The climate control system of claim 14, further comprising a controller configured to regulate at least one operational aspect of the fluid module.
